(19) United States
(12) Patent Application Publication
(10) Pub. No.: US 2023/0292793 A1
(43) Pub. Date: Sep. 21, 2023

(54) METHOD FOR ELIMINATING OR REDUCING THE CONCENTRATION OF ONE OR BOTH GEOSMIN AND 2-METHYL ISOBORNEOL WITHIN THE BODY OF FISH AND CRUSTACEANS AND COMPOSITION FOR USING THE SAME

(71) Applicant: HAYASHIKANE SANGYO CO., LTD., Shimonoseki-s hi Yamaguchi (JP)

(72) Inventors: Kenzo MISHIRO, Shimonoseki-shi Yamaguchi (JP); Kenji MIYAKE, Shimonoseki-shi Yamaguchi (JP)

(21) Appl. No.: 18/013,561

(22) PCT Filed: Jun. 29, 2020
(86) PCT No.: PCT/JP2020/025484

§ 371 Date: Dec. 29, 2022

(51) Int. Cl. A23K 50/80; A23K 10/37; A23K 20/20; A01K 61/10; A01K 61/59

(52) U.S. Cl. CPC A23K 50/80; A23K 10/37; A23K 20/20; A01K 61/10; A01K 61/59

(57) ABSTRACT

A method for eliminating or reducing the concentrations of one or both of geosmin and 2-methylisoborneol within the body of fish and crustaceans comprising steps for: providing a composition containing wood vinegar liquid and amorphous carbon; and administrating the composition orally to fish and crustaceans is disclosed. Also, a composition for eliminating or reducing the concentration of one or both of geosmin and 2-methylisoborneol within the body of fish and crustaceans containing wood vinegar liquid and amorphous carbon, for example, in an amount of 3 to 5 kg per 1 L of wood vinegar liquid is disclosed. By the present disclosure, a method for eliminating or reducing the concentrations of one or both of geosmin and 2-methylisoborneol within the body of fish and crustaceans safely and efficiently and a composition for eliminating or reducing the concentrations of one or both geosmin and 2-methylisoborneol within the body of fish and crustaceans are provided.

### TECHNICAL FIELD

The present invention relates to a method for eliminating or reducing the concentration of one or both geosmin and 2-methylisoborneol within the body of fish and crustaceans and a composition for eliminating or reducing the concentration of one or both geosmin and 2-methylisoborneol within the body of fish and crustaceans.

### BACKGROUND ART

Freshwater fish and farmed fish have a characteristic muddy odor and or flavor, which hinders eating, spoils taste and greatly diminishes the commercial value as edible fish and crustaceans. Geosmin ((4S,4aS,8aR)-4,8a-dimethyl-1,2,3,4,5,6,7,8-octahydronaphthalen-4a-ol) and 2-methylisoborneol (rel-(1R,2R,4R)-1,2,7,7-tetrahydrobicyclo[2.2.1]heptan-2-ol) are known to be responsible for these odors and flavors. These substances are produced by microorganisms such as cyanobacteria that occur in eutrophic water systems, which are thought to cause fish and crustaceans to produce an odor or flavor when it is absorbed and concentrated in the muscles, liquids or skin. The human sensory system is sensitive to these off-flavor substances and are detectable at low concentrations in order of a few ppb. For example, Patent Document 1 discloses a method for measuring the concentration of geosmin in farmed fish and determining the presence or absence of characteristic odor of the farmed fish derived from geosmin according to analysis results. The same problem equally applies to crustaceans such as shrimps, prawns and lobsters.

Since geosmin and 2-methylisoborneol are decomposed under acidic conditions, the odor of geosimin and 2-methylisoborneol may be suppressed by cooking with acidic seasonings such as vinegar. However, the cooking method is limited and sufficient geosmin and 2-methylisoborneol removal is difficult.

### SUMMARY OF INVENTIONS

There is no known method thus far for eliminating or reducing concentrations of geosmin and 2-methylisoborneol within the body of fish and crustaceans.

### Problem to be Solved by the Inventions

The present inventions are achieved under such circumstances and the objective of such inventions is to provide a method for eliminating or reducing the concentration of one or both geosmin and 2-methylisoborneol within the body of fish and crustaceans safely and efficiently and a composition for eliminating or reducing concentrations of one or both of geosmin and 2-methylisoborneol in cultured water farmed fish and crustaceans.

### Means to Solve the Problem

First aspect of the invention along with the object mentioned above solves the problem as mentioned above by providing a method for eliminating or reducing the concentration of one or both of geosmin and 2-methylisoborneol within the body of fish and crustaceans comprising steps for:
providing a composition containing wood vinegar liquid and amorphous carbon; and
administrating the composition orally to the fish and crustaceans.

In the present disclosure, “eliminating” one or both geosmin and 2-methylisoborneol within the body of fish and crustaceans means reducing the concentration of one or both geosmin and 2-methylisoborneol within the body of fish and crustaceans to lower than detectable limits using any analyzing means known as gas chromatography.

In the method according to the first aspect of the invention, composition mixed in a feed may be administered orally to the fish and crustaceans in an amount of 10 μg to 100 g per day per 1 kg of fish and crustaceans body weight.

Second aspect of the invention solves the problem as mentioned above by providing a method for eliminating or reducing the concentration of one or both geosmin and 2-methylisoborneol within the body of fish and crustaceans comprising steps for:
providing a composition containing wood vinegar liquid and amorphous carbon;
dispersing the composition in cultured water; and
culturing fish and crustaceans in cultured water in which the composition is dispersed.

In the method according to the second aspect of the invention, the composition may be dispersed in cultured water in an amount of 10 μg to 1 g per day per 1 L of cultured water.

In the method according to the first and the second aspect of the invention, the composition may contain amorphous carbon in an amount of 3 to 5 kg per 1 L of wood vinegar liquid.

In the method according to the first and the second aspect of the invention, fish and crustaceans are for example, any one of Order Perciformes (Scombridae Thunnus, Scombridae Katsuwonus, Scombridae Euthynnus, Carangidae Trachurus, Carangidae Seriola, Carangidae Pseudocaranx, Carangidae Trachinotus, Carangidae Maccullochella, Sparidae, Oplegnathus, Latidae Lates, Serranidae Cromileptes, Serranidae Plectropomus, Serranidae Epinephelus, Centrachidae Micropterus, Lacteolabracidae Lateolabrax and Cichilidae Oreochromis), Order Cypriniformes (Cyprinidae Cyprinus), Order Siluriformes (Siluridae Silurus, Clariidae Clarias, Pangasiidae Pangasianodon and Bagridae Hemibagrus), Order Clupeiformes (Salmonidae Oncorhynchus, Salmonidae Salvelinus and Salmonidae Salmo), Order Anguilliformes (Anguillidae Anguilla), Pleuronectiformes (Paralichthyidae Paralichthys) and Order Tetraodontiformes (Tetraodontidae Takifugu) and Order Decapoda (Litopenaeus vannamei, Litopenaeus stylirostris, Penaeus monodon, Penaeus shrimps nei, Penaeus indicus, Penaeus penicillatus, Marsupenaeus japonicus, Fenneropenaeus chinensis, Fenneropenaeus indicus, Metapenaeus ensis, Metapenaeus spp, Metapenaeus monoceros, Macrobrachium rogenbergii, Palaemon varians and Melicertus kerathurus).

The third aspect of the invention solves the problem as mentioned above by providing a composition for eliminating or reducing concentrations of one or both of geosmin and 2-methylisoborneol within the body of fish and crustaceans containing wood vinegar liquid and amorphous carbon.

The composition according to the third aspect of the invention may contain amorphous carbon in an amount of 3 to 5 kg per 1 L of wood vinegar liquid.

### Effect of the Invention

According to present inventions, a composition for eliminating or reducing the concentration of one or both of geosmin and 2-methylisoborneol within the body of fish and crustaceans safely and efficiently by simply administrating orally to the fish and crustaceans or dispersing in the culture water and a method for eliminating or reducing the concentration of one or both geosmin and 2-methylisoborneol within the body of fish and crustaceans using the same are provided.

### DESCRIPTION OF EMBODIMENTS

Hereinafter, the embodiments of the present invention will then be described and provided for the understanding of the present invention. A method for eliminating or reducing the concentration of one or both of geosmin and 2-methylisoborneol within the body of fish and crustaceans according to first embodiment of the present invention comprises steps for: providing a composition containing wood vinegar liquid and amorphous carbon; and administrating the composition orally to fish and crustaceans.

A composition for eliminating or reducing the concentration of one or both of geosmin and 2-methylisoborneol within the body of fish and crustaceans according to second embodiment of the present invention is a composition used for the method according to the first embodiment of the present invention which contains wood vinegar liquid and amorphous carbon.

As fish and crustaceans subject to the method for eliminating or reducing concentration of one or both geosmin and 2-methylisoborneol within the body of fish and crustaceans according to the first embodiment of the present invention, any fresh and sea water fish and crustaceans cultured in closed environments such as culture ponds and cultured tanks are included without any limitation. Specific fish species examples are as follows.

### Order Perciformes

Family Scombridae
Genus Thunnus: Pacific bluefin tuna (Thunnus orientalis), Southern bluefin tuna (Thunnus maccoyii), Yellowfin tuna (Thunnus albacares)
Genus Katsuwonus: Bonito (Katsuwonus pelamis)
Genus Euthynnus: Kawakawa (Euthynnus affinis)

Family Carangidae
Genus Trachurus: Japanese jack mackerel (Tracurus japonicus)
Genus Seriola: Japanese amberjack (Seriola quinqueradiata), Yellowtail amberjack (Seriola lalandi Valenciennes, Grater amberjack (Seriola dumerili), Highfin jack (Seriola rivoriana Valencinnes)
Genus Pseudocaranx: White trevally (Pseudocaranx dentax)
Genus Trachinotus: Snubnose pompano (Trachinotus blochii)
Genus Maccullochella: Murray cod (Maccullochella peelii)

Family Sparidae: Red seabream (Pagrus major)

Family Oplegnathus: Striped beakfish (Oplegnathus fasciatus), Spotted knifejaw (Oplegnathus punctatus)

Family Latidae
Genus Lates: Barramundi (Lates calcarifer)

Serranidae
Genus Cromileptes: Humpback grouper (Chromileptes altivelis)
Genus Plectropomus: Leopard coral grouper (Plectropomus leopardus)
Genus Epinephelus: Blacktip grouper (Epinephelus fasciatus),

Grouper (Epinephelus septemfasciatus), Longtooth grouper (Epinephelus bruneus), Giant grouper (Epinephelus lanceolatus)

Family Centrachidae
Genus Micropterus: Largemouth bass (Micropterus salmoides)

Family Lacteolabracidae
Genus Lateolabrax: Japanese sea bass (Lateolabrax japonicus)

Family Cichilidae
Genus Oreochromis: Mosambique tilapia (Oreochromis mossambicus), Nile tilapia (Oreochromis niloticus)

### Order Cypriniformes

Family Cyprinidae
Genus Cyprinus: Common carp (Cyprinus carpio) Order Siluriformes

Family Siluridae
Genus Silurus: Japanese common catfish (Silurus asotus)

Family Clariidae
Genus Clarias: Walking catfish (Clarias batrachus)

Family Pangasiidae
Genus Pangasianodon: Iridescent shark (Pangasianodon hypophthalmus)

Family Bagridae
Genus Hemibagrus: Hemibagrus olyroides

### Order Clupeiformes

Family Salmonidae
Genus Oncorhynchus: Salmon (Oncorhynchus keta), Black kokanee (Oncorhynchus nerka kawamurae), Rainbow trout (Oncorhynchus mykiss), Seema (Oncorhynchus masou)
Genus Salvelinus: Whitespotted char (Salvelinus leucomaenis)
Genus Salmo: Brown trout (Salmo trutta), Atlantic salmon (Salmo salar)

### Order Anguilliformes

family Anguillidae
Genus Anguilla: Japanese eel (Anguilla japonica), European eel (Anguilla anguilla), Anguilla rostrate, Anguilla bicolor, Anguilla marmorata

### Order Pleuronectiformes

Family Paralichthyidae
Genus Paralichthys: Bastard halibut (Paralichthys olivaceus)

### Order Tetraodontiformes

Family Tetraodontidae
Genus Takifugu: Tiger puffer (Takifugu rubripes)

Specific examples of crustaceans are as follows.

### Order Decapoda

Family Penaeidae
Genus Litopenaeus: Whiteleg shrimp (Litopenaeus vannamei), Blue prawn (Litopenaeus stylirostris)
Genus Penaeus: Black tiger prawn (Penaeus monodon), Red-spot prawn (Penaeus shrimps nei), Indian White Shrimp (Penaeus indicus), Redtail prawn (Penaeus penicillatus)
Genus Marsupenaeus: Japanese tiger prawn (Marsupenaeus japonicus)
Genus Fenneropenaeus: Chinese white shrimp (Fenneropenaeus chinensis), Indian prawn (Fenneropenaeus indicus)
Genus Metapenaeus: Offshore greasyback prawn (Metapenaeus ensis), Metapenaeus shrimps nei (Metapenaeus spp), Speckled shrimp (Metapenaeus monoceros)
Genus Macrobrachium: Giant river prawn (Macrobrachium rogenbergii)
Genus Palaemon: Atrantic ditch shrimp (Palaemon varians)
Genus Melicertus: Caramote prawn (Melicertus kerathurus)

### Wood Vinegar Liquid

The wood vinegar liquid used for producing the composition according to the second embodiment of the invention is produced by the distillation of liquid material obtained by cooling wood gases such as smoke and vapor generated by dry distillation of woody materials. Any woody materials including plants belonging to the genus Aphuzeria, Aphuzeria, Salanoki, Teak, and others may be used without limitation. More specifically, the plant used as the woody material include broadleaf trees such as live oak, oak, beech and merbau wood; coniferous trees such as cedar, pine and cypress; bambuseae such as bamboo and sassafras; and coconut. Using trunks and branches of these plants are preferred. The production method of wood vinegar liquid is illustrated in more detail. At first, the liquid material is obtained by collecting and cooling woody gases generated by dry distillation of the woody material used to produce products such as charcoal for example. As this liquid material or optionally crude distillate is obtained by steam or vacuum distillation liquid material is allowed to stand still, it separates into three layers: the upper layer substantially consisting of hydrophobic oils, intermediate layer substantially consisting of aqueous solution and lower layer substantially consisting of wood tar. The aqueous solution at the intermediate aqueous layer collected may be used as the wood vinegar liquid. The aqueous solution at the intermediate level may be further distilled and fractionated to obtain the desired fractions, and if necessary, it may be further treated by, for example, redistilled or treatment with activated carbon, which may be used as a wood vinegar liquid.

On the other hand, the wood vinegar liquid may be obtained by steam or vacuum distillation of wood tar from the lower layer, which may be used as the wood vinegar liquid. Furthermore, wood vinegar obtained using this method may be distilled and collect the desired fraction and used after further treatment such as re-distillation or filtrate though an active charcoal filter. Alternately, wood vinegar liquid may be obtained by directly distilling the liquid material or the crude distillate mentioned above to collect the desired fraction and further treatment such as the re-distillation, treatment with active charcoal to remove harmful components such as tar, wood creosote, formaldehyde and methanol. The distillation conditions required for obtaining the desired fraction is, for example, collecting the fraction at 100 to 110° C. under atmospheric pressure. The fractions obtained by a plurality of steps may be combined to use as the wood vinegar liquid used for producing the composition according to the second embodiment of the present invention. As a raw material for the wood vinegar liquid, the non-utilized material discharged in the manufacturing process of wood creosote may be used as used as a pharmaceutical product.

### Amorphous Carbon

Amorphous carbon used for producing the composition is obtained by milling an amorphous carbon material such as charcoal and active charcoal through milling machine and other equipment. If necessary, it may be classified to a predetermined particle size using any known classification method such as a sieve.

Particle size is not particularly limited and, for example, a particle size such that 75% or more of the total mass is within the range of 10 to 300 μm in diameter is preferred and a particle size such that 75% or more of the total mass is within the range of 20 to 100 μm in diameter is preferable. Smaller particle size is undesirable since secondary particles are formed by agglomeration. Larger particle sizes are undesirable due to fish body absorption and penetration. The particle size may be measured by a laser diffraction scattering particle size analyzer, automatic ultra-centrifugal particle size distribution analyzer, and other equivalent equipment.

A detailed explanation of woody material used as a raw material for charcoal is omitted because it is the same as the woody material used as the raw material of wood vinegar liquid. The raw materials in active charcoal include plant materials such as coconut shells and walnut shells and carbon materials such as coal and petroleum.

The composition is produced by mixing wood vinegar liquid and amorphous carbon, by which the wood vinegar liquid is adsorbed onto the amorphous carbon having a porous structure and by performing a post-treatment such as freeze drying as required. The wood vinegar liquid may be mixed with amorphous carbon as it is or it may be mixed with amorphous carbon after diluted with a solvent such as water. The mixing ratio of wood vinegar liquid and amorphous carbon is, for example, 3-5 kg of amorphous carbon per 1 L of wood vinegar liquid. Commercially available compositions such as those described above may also be used as the composition.

The concentration of one or both geosmin and 2-methylisoboeneol within the body of fish and crustaceans may be reduced or eliminated by administrating the composition obtained orally.

Although the methods for orally administrating the composition to fish and crustaceans is not particularly limited, for example, administrating the composition by way of feed containing the composition is preferred since it is an efficient way to control the composition dosage whilst controlling feed efficiency. The dosage of the composition is, for example, 10 μg to 100 g/day per kg of fish and crustaceans body weight, preferably 10 mg to 5 g/day. The amount of composition in the feed may be calculated based on the amount of feed per day and the total body weight of fish and crustaceans in the culture tank.

A method for eliminating or reducing the concentration of one or both of geosmin and 2-methylisoborneol within the body of fish and crustaceans according to another embodiment of the present invention comprises steps for: providing a composition containing wood vinegar liquid and amorphous carbon; dispersing the composition in cultured water; and culturing fish and crustaceans in cultured water in which the composition is dispersed. Although the reason why dispersing the composition into culture water reduces the concentration of one or both of geosmin and 2-methylisoborneol in the body of fish and crustaceans is unclear, it is considered decreasing the concentration of geosmin and 2-methylisoborneol in cultured water by the addition of the composition is one possible reason. The amount of dispersion of the composition is, for example, 10 μg to 1 g per 1 L of cultured water.

### EXAMPLES

Examples for confirming the effect of the present invention are illustrated as follows.

### Example 1: Oral Administration of the Composition to Barramundi

As a composition containing wood vinegar liquid and amorphous carbon, Super Nekkarich for fisheries made by Miyazaki Midori Pharms, Inc. was mixed with feed for Barramundi cultivation in two cultured ponds (ponds H and F). After dividing the fish group into three and four groups, the fish were administered orally by way of feed containing the composition at a rate of 0.15 g/day per 1 kg of fish body weight for a period of 30 days. The concentrations of geosmin and 2-methylisoborneol in the treated fish were measured (test area). The group fed feed that did not contain the composition was used as a control area. The results are shown in Table 1. As is evident from Table 1, in both of the two test areas, substantial decreases in the concentration of geosmin and 2-methylisoborneol (below 0.1 ppb; in the sensory tests, the panelists having excellent olfactory sensitivity did not detect an odor associated with off-flavor compounds from geosmin and or 2-methylisoborneol) was observed. In Table 1, “N.D.” means “not detected”.

TABLE 1

| Sample Name | Geosmin (ppb) | 2-Methylisoborneol (ppb) |
|---|---|---|
| Pond H: Control Area | 2.6 | 0.4 |
| Pond H: Test Area 1 | 0.9 | 0.2 |
| Pond H: Test Area 2 | 0.7 | 0.2 |
| Pond F: Control Area | 0.2 | 0.2 |
| Pond F: Test Area 1 | 0.1 | 0.1 |
| Pond F: Test Area 2 | 0.1 | 0.1 |
| Pond F: Test Area 3 | <0.1 | <0.1 |

### Example 2: Addition of the Composition into the Culture Water

The concentrations of geosmin and 2-methylisoborneol in cultured Murray Cod tanks (Capacity: 25,000 L=25 t, not equipped with a filtration system (hereinafter, referred to as “Culture tanks”) and equipped with the filtration system (hereinafter referred to as “Filtration Tanks”) in which Super Nekkarich for fisheries made by Miyazaki Midori Pharms, Inc. (0.18 to 0.36 g per 1 L of cultured water, converted from concentrations in the feed) were added (test area) and Super Nekkarich was not added (control area) were measured. The results are shown in Table 2 below. For both Culture Tanks and Filtration Tanks, significant reductions of geosmin and 2-methylisoborneol by the addition of the composition was observed.

TABLE 2

| | Geosmin | 2-Methylisoborneol |
|---|---|---|
| Sample Name | (ng/L) | (ng/L) |
| Culture Tank: Test Area | 15 | 39 |
| Culture Tank: Control Area | 20 | 76 |
| Filter Tank: Test Area | 15 | 42 |
| Filter Tank: Control Area | 19 | 97 |

### CITATION LIST

### Patent Literature

[Patent Literature 1] JP2003-70373A

1. A method eliminating or reducing the concentration of one or both geosmin and 2-methylisoborneol within the body of fish and crustaceans comprising steps for:
providing a composition containing wood vinegar liquid and amorphous carbon; and
administrating the composition orally to fish and crustaceans.

2. The method according to claim 1, wherein the composition mixed in a feed is administered orally to fish and crustaceans in an amount of 10 μg to 100 g per day per 1 kg of the body weight.

3. A method for eliminating or reducing the concentration of one or both geosmin and 2-methylisoborneol within the body of fish and crustaceans comprising steps for:
providing a composition containing wood vinegar liquid and amorphous carbon;
dispersing the composition into cultured water; and
culturing fish and crustaceans in cultured water in which the composition is dispersed.

4. The method according to claim 3, wherein the composition is dispersed in cultured water in an amount of 10 μg to 1 g per day per 1 L.

5. The method according to claim 1, wherein the composition contains amorphous carbon in an amount of 3 to 5 kg per 1 L of wood vinegar liquid.

6. The method according to claim 1, wherein fish and crustaceans are any of Order Perciformes (Scombridae Thunnus, Scombridae Katsuwonus, Scombridae Euthynnus, Carangidae Trachurus, Carangidae Seriola, Carangidae Pseudocaranx, Carangidae Trachinotus, Carangidae Maccullochella, Sparidae, Oplegnathus, Latidae Lates, Serranidae Cromileptes, Serranidae Plectropomus, Serranidae Epinephelus, Centrachidae Micropterus, Lacteolabracidae Lateolabrax and Cichilidae Oreochromis), Order Cypriniformes (Cyprinidae Cyprinus), Order Siluriformes (Siluridae Silurus, Clariidae Clarias, Pangasiidae Pangasianodon and Bagridae Hemibagrus), Order Clupeiformes (Salmonidae Oncorhynchus, Salmonidae Salvelinus and Salmonidae Salmo), Order Anguilliformes (Anguillidae Anguilla), Pleuronectiformes (Paralichthyidae Paralichthys), Order Tetraodontiformes (Tetraodontidae Takifugu) and Order Decapoda (Litopenaeus vannamei, Litopenaeus stylirostris, Penaeus monodon, Penaeus shrimps nei, Penaeus indicus, Penaeus penicillatus, Marsupenaeus japonicus, Fenneropenaeus chinensis, Fenneropenaeus indicus, Metapenaeus ensis, Metapenaeus spp, Metapenaeus monoceros, Macrobrachium rogenbergii, Palaemon varians and Melicertus kerathurus).

7. The method according to claim 3, wherein the composition contains amorphous carbon in an amount of 3 to 5 kg per 1 L of wood vinegar liquid.

8. The method according to claim 3, wherein the fish and crustaceans are any of Order Perciformes (Scombridae Thunnus, Scombridae Katsuwonus, Scombridae Euthynnus, Carangidae Trachurus, Carangidae Seriola, Carangidae Pseudocaranx, Carangidae Trachinotus, Carangidae Maccullochella, Sparidae, Oplegnathus, Latidae Lates, Serranidae Cromileptes, Serranidae Plectropomus, Serranidae Epinephelus, Centrachidae Micropterus, Lacteolabracidae Lateolabrax and Cichilidae Oreochromis), Order Cypriniformes (Cyprinidae Cyprinus), Order Siluriformes (Siluridae Silurus, Clariidae Clarias, Pangasiidae Pangasianodon and Bagridae Hemibagrus), Order Clupeiformes (Salmonidae Oncorhynchus, Salmonidae Salvelinus and Salmonidae Salmo), Order Anguilliformes (Anguillidae Anguilla), Pleuronectiformes (Paralichthyidae Paralichthys) and Order Tetraodontiformes (Tetraodontidae Takifugu) and Order Decapoda (Litopenaeus vannamei, Litopenaeus stylirostris, Penaeus monodon, Penaeus shrimps nei, Penaeus indicus, Penaeus penicillatus, Marsupenaeus japonicus, Fenneropenaeus chinensis, Fenneropenaeus indicus, Metapenaeus ensis, Metapenaeus spp, Metapenaeus monoceros, Macrobrachium rogenbergii, Palaemon varians and Melicertus kerathurus).

9. A composition for eliminating or reducing the concentration of one or both geosmin and 2-methylisoborneol within the body of fish and crustaceans containing wood vinegar liquid and amorphous carbon.

10. The composition according to claim 9, wherein the composition contains amorphous carbon in an amount of 3 to 5 kg per 1 L of wood vinegar liquid.
